(19) United States
(12) Patent Application Publication
(10) Pub. No.: US 2005/0259108 A1
(43) Pub. Date: Nov. 24, 2005

(54) System and method for dynamically generating images using repeatable textures

(76) Inventor: Brett Chladny, Plano, TX (US)

Correspondence Address: FISH & RICHARDSON P.C., 1717 MAIN STREET, SUITE 5000, DALLAS, TX, 75201, US

(21) Appl. No.: 11/074,204

(22) Filed: Mar. 7, 2005

Related U.S. Application Data
(60) Provisional application No. 60/573,158, filed on May 21, 2004.

(51) Int. Cl. G09G 5/00

(52) U.S. Cl. 345/588

(57) ABSTRACT

In one embodiment, software is operable to identify a plurality of repeatable textures. The texture coordinates used by at least one of the plurality of repeatable textures is then modified using the software. A new texel fragment is dynamically computed for an image based, at least in part, on the identified plurality of repeatable textures.

### RELATED APPLICATION

This application claims the priority under 35 U.S.C. §119 of provisional application Ser. No. 60/573,158 filed May 21, 2004.

### TECHNICAL FIELD

This disclosure generally relates to visual simulation or imaging and, more specifically, to a system and method for dynamically generating images using repeatable textures.

### BACKGROUND

Texture memory may be a limited resource such as, for example, 256 MB on current commodity personal computer graphics cards. Visual simulation systems typically use texture repetition to add visual quality to a scene by providing a high level of detail or image fidelity, while simultaneously not requiring an excess amount of texture memory. Conventional textures usually include a plurality of texture elements and are rendered by making the texture element to the right of the right-most texture element be the left-most texture element of the same texture. Similarly, the texture element above the top-most texture element is the bottom-most texture element of the same texture. This repeatable pattern may be repeated as many times as desired by the developer or artist. This repetition, while conserving texture memory, can cause visually distracting patterns. Indeed, if the repeatable texture is used to represent a large organic entity or scene that does not normally have a visible pattern in it, such as a grass or water texture, the visible pattern of the texture may be repeated multiple times in the simulation or graphic, often causing relatively large patterns in the image.

### SUMMARY

This disclosure provides a system and method for dynamically generating images using repeatable textures. In one embodiment, software is operable to identify a plurality of repeatable textures. The texture coordinates of at least one of the plurality of repeatable textures is then dynamically modified using the software. A new texel fragment is dynamically computed for an image based, at least in part, on the identified plurality of repeatable textures. The details of one or more embodiments of the invention are set forth in the accompanying drawings and the description below. Particular features, objects, and advantages of the disclosure will be apparent from the description and drawings and from the claims.

### DESCRIPTION OF DRAWINGS

FIG. 1 illustrates a system for dynamically generating images based on repeatable textures in accordance with one embodiment of the present disclosure;

FIGS. 2A-C illustrates a plurality of example textures for use by the system of FIG. 1;

FIGS. 3A-D illustrate example visual simulations based on the example textures of FIG. 2;

FIG. 4 illustrates an example algorithm used to dynamically generate the example visual simulation of FIG. 3D in accordance with one embodiment of the present disclosure; and

FIG. 5 is a flowchart illustrating an example method for dynamically generating images based on repeatable textures in accordance with one embodiment of the present disclosure.

### DETAILED DESCRIPTION

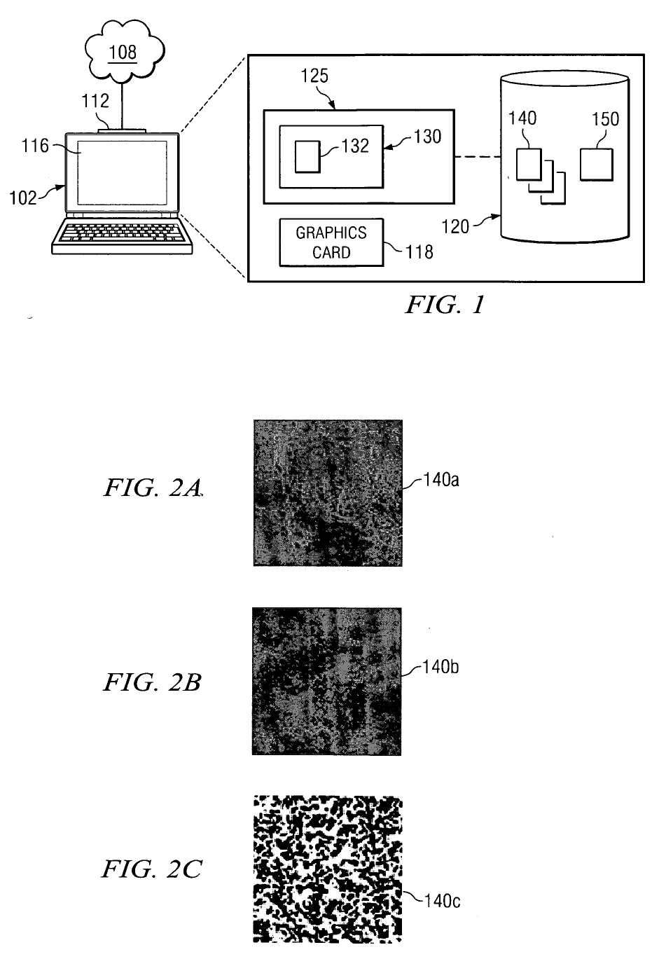

FIG. 1 illustrates a computer system 102 for developing or generating images 150 using repeatable textures in accordance with one embodiment of the present disclosure. Generally, system 102 provides a developer with an environment operable to use one or more repeatable textures 140, often the coordinates of which have been dynamically modified, to generate an image 150. More specifically, system 102 is operable to dynamically combine multiple layers of repeatable textures 140 by combining the different properties of the plurality of repeatable textures 140 after changing the texture coordinates of at least one of the repeatable textures 140. Therefore, system 102 may allow the developer to easily generate landscape or other organic entity images 150 with reduced or eliminated visible patterns. In certain embodiments, this is accomplished by scaling, rotating, translating, or otherwise modifying the texture coordinates assigned to each vertex of one of a plurality of matched repeatable textures 140, thereby reducing the probability of distracting patterns and the time required by the developer to manually modify each texture 140. The resulting texel fragments are dynamically computed or generated, which will reduce the use of texture memory. Put another way, when image 150 is rasterized, a texel fragment is dynamically computed for each pixel fragment based on input texture elements from repeatable textures 140. The term “dynamically,” as used herein, generally means that certain processing is determined, at least in part, at run-time based on one or more variables. The term “automatically,” as used herein, generally means that the appropriate processing is substantially performed by at least part of system 100. It should be understood that “automatically” further contemplates any suitable user or developer interaction with system 102 without departing from the scope of this disclosure.

At a high level, system 102 is a development workstation or computer 102 that presents a development environment 130 operable to identify a plurality of repeatable textures 140, change the display properties of at least one of the plurality of repeatable textures 140, and dynamically compare new texel fragments for image 150 based, at least in part, on the plurality of identified repeatable textures 140. Computer 102 is typically located in a distributed client/server system that allows the user to generate images and publish or otherwise distribute the images to an enterprise or other users for any appropriate purpose. But, as illustrated, computer 102 may be a standalone computing environment or any other suitable environment without departing from the scope of this disclosure. Generally, FIG. 1 provides merely one example of computers that may be used with the disclosure. For example, computer 102 may comprise a computer that includes an input device, such as a keypad, touch screen, mouse, or other device that can accept information, and an output device that conveys information associated with the operation of computer 102, including digital data and visual information. Both the input device and output device may include fixed or removable storage media such as a magnetic computer disk, CD-ROM, or other suitable media to both receive input from and provide output to users of computer 102 through the display. As used in this document, the term “computer” is intended to encompass a personal computer, touch screen terminal, workstation, network computer, kiosk, wireless data port, wireless or wireline phone, personal data assistant (PDA), one or more processors within these or other devices, or any other suitable processing device. For example, the present disclosure contemplates computers other than general purpose computers as well as computers without conventional operating systems. Computer 102 may be adapted to execute any operating system including Linux, UNIX, Windows, Windows Server, or any other suitable operating system operable to present windows. According to one embodiment, computer 102 may be communicably coupled with a web server (not illustrated). As used herein, “computer 102,” “developer,” and “user” may be used interchangeably as appropriate without departing from the scope of this disclosure. Moreover, for ease of illustration, each computer 102 is described in terms of being used by one user. But this disclosure contemplates that many users may use one computer or that one user may use multiple computers to develop new texture elements.

Illustrated computer 102 includes graphics card 118, memory 120, and processor 125 and comprises an electronic computing device operable to receive, transmit, process, and store data associated with generating images, as well as other data. Graphics card 118 is any hardware, software, or logical component, such as a video card or display adapter, operable to generate or present a display to the user of computer 102 using Graphical User Interface (GUI) 116. Indeed, while illustrated as a single graphics card 118, computer 102 may include a plurality of graphics cards 118. In certain embodiments, graphics card 118 includes video or texture memory that is used for storing or processing at least a portion of graphic to be displayed. Graphics card 118 may utilize any appropriate standard (such as Video Graphics Array (VGA)) for communication of data from processor 125 to GUI 116. While illustrated separately, it will be understood that graphics card 118 (and/or the processing performed by card 118) may be included in one or more of the other components such as memory 120 and processor 125. Processor 125 executes instructions and manipulates data to perform the operations of computer 102 such as, for example, a central processing unit (CPU), a blade, an application specific integrated circuit (ASIC), or a field-programmable gate array (FPGA). Although FIG. 1 illustrates a single processor 125 in computer 102, multiple processors 125 may be used according to particular needs and reference to processor 125 is meant to include multiple processors 125 where applicable. In the illustrated embodiment, processor 125 executes development environment 130, which performs at least a portion of the computation of a new texel fragment, using graphics card 118, based on a plurality of repeatable textures 140 after changing the texture coordinates of at least one of the textures 140.

Development environment 130 could include any software, firmware, or combination thereof operable to develop graphics for presentation to one or more users or viewers and present a design engine 132 for developing, customizing, or otherwise generating images 150 using repeatable textures 140. Development environment 130 may be written or described in any appropriate computer language including C, C++, Java, J#, Visual Basic, Perl, assembler, any suitable version of 4GL, and others or any combination thereof. It will be understood that while development environment 130 is illustrated in FIG. 1 as multiple modules such as, for example, a design engine 132, the features and functionality performed by this engine may be performed by a single multi-tasked module. Further, while illustrated as internal to computer 102, one or more processes associated with development environment 130 may be stored, referenced, or executed remotely. Moreover, development environment 130 may be a child or sub-module of another software module (not illustrated) without departing from the scope of this disclosure. At a high level, design engine 132 is any algorithm, function, method, library, service, window, diagram box, module, or application implementing at least a portion of the functionality for dynamically computing new repeatable textures 140. For example, design engine 132 may be a diagram box operable to receive selections and modifications of texture 140 from the developer. In another example, design engine 132 may automatically modify one or more texture coordinates used by the selected textures 140. In yet another example, design engine 132 may automatically generate one or more textures 140 for use in generating image 150. For ease of understanding, design engine 132 is illustrated as a sub-module of development environment 130. But it will be understood that design engine 132 and development environment 130 may represent separate processes or algorithms in one module and, therefore, may be used interchangeably as appropriate.

Memory 120 may include any local or remote memory or database module and may take the form of volatile or non-volatile memory including, without limitation, magnetic media, optical media, random access memory (RAM), read-only memory (ROM), removable media, or any other suitable memory component. In the illustrated embodiment, memory 120 includes one or more repeatable textures 140 and images 150, but memory 120 may also include any other appropriate data such as history log, DLLs, an operating system, security policies, and such.

Repeatable textures 140 include any parameters, variables, tags, algorithms, or other data structures operable to present a graphical texture. As generally described herein, texture 140 includes a plurality of texture elements (sometimes referred to as “texels”). Texels generally refer to what is retrieved from texture memory when the graphics sub-system, such as 118, asks for the texture information that should be used for a given pixel in the frame buffer. The retrieval typically includes processes like minifiction, magnification, anisotropic filtering, and such. In other words, each texture element characterizes the smallest graphical element in two-dimensional electronic texture mapping to the generation of image 150, which gives the visual impression of a textured three-dimensional surface. These textures 140 are repeatable, thereby allowing a plurality of instances of at least one of textures 140 to be joined to create the organic image 150. For example, FIG. 2A illustrates an example first repeatable texture 140a, FIG. 2B illustrates a second repeatable texture 140b, and FIG. 2C illustrates a third repeatable texture 140c. In the illustrated embodiment, third repeatable texture 140c includes a number of black and white texture elements, with little or no gray. These black and white texture elements may be scaled from 0 to 1 (or the other way around), respectively, in order to compute, decide or otherwise determine the appropriate layering of other repeatable textures 140. It will be understood that repeatable generally means that the texture element to the right of the right-most texture element in the respective texture 140 is the left-most texture element of the same texture 140—moreover, the texture element above the top-most texture element in the respective texture 140 is the bottom-most texture element of the same texture 140. In particular embodiments, two or more repeatable textures 140 may be distinct from one another and remain repeatable among the others. Said another way, a first repeatable texture 140 and a second repeatable texture 140 may be different textures, but may also be used interchangeably or collectively to generate organic image 150.

Repeatable textures 140 may be automatically or manually created, purchased from vendors, downloaded, or otherwise identified and stored using any technique. For example, repeatable textures 140 may be stored in a persistent file available to one or more users. In one embodiment, repeatable textures 140 may be stored using one or more extensible Markup Language (XML) documents or other data structure including tags. In another embodiment, repeatable textures 140 may be stored or defined in various data structures as in a relational database described in terms of SQL statements or scripts, Virtual Storage Access Method (VSAM) files, flat files, Btrieve files, comma-separated-value (CSV) files, object-oriented database, internal variables, or one or more libraries. In short, repeatable textures 140 may be one table or file or a plurality of tables or files stored on one computer or across a plurality of computers in any appropriate format. Further, repeatable textures 140 may be local or remote without departing from the scope of this disclosure.

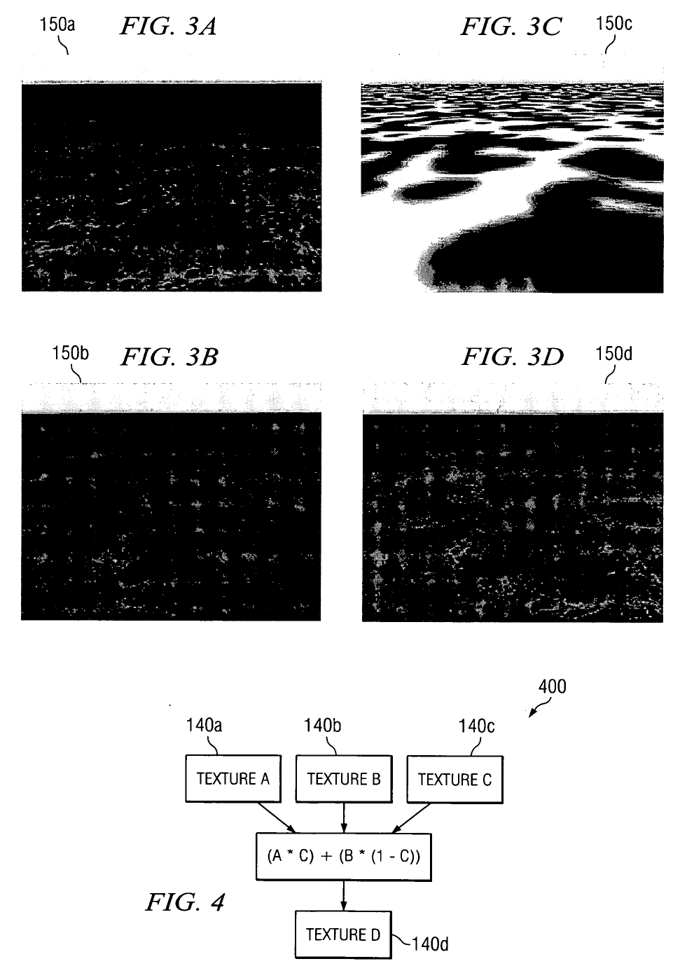

Images 150 include a plurality of texture elements and are used for presentation of various graphics to the user. In certain embodiments, image 150 includes or presents a graphic entity that comprises a plurality of instances of at least one repeatable texture 140. For example, the graphic entity may be grasslands, water, clouds, or some other organic or broad scene. But it will be understood that image 150 may use repeatable textures 140 without including such an organic or broad graphic entity without departing from the scope of this disclosure. Returning to the example textures 140 in FIGS. 2A-C, FIG. 3A illustrates a first image 150a generated through repeating first texture 140a, FIG. 3B illustrates a second image 150b generated through repeating second texture 140b, and FIG. 3C illustrates a third image 150c generated through repeating third texture 140c. In certain embodiments, two or more repeatable textures 140 may be joined or layered to fairly quickly generate image 150, as illustrated in FIG. 3D. Fourth image 150d includes repetitions of two source textures, 140a and 140b respectively, and one decisional texture, in this case third texture 140c. As described in more detail below, third texture 140c may be used to determine, on a texel fragment by texel fragment basis, when to use a portion of first texture 140a or second texture 140b. While described in terms of two source textures 140, it will be understood that any number of source textures 140 may be used without departing from the scope of this disclosure. As with textures 140, images 150 may stored in any format after computation and may be in one table or file or a plurality of tables or files stored on one computer or across a plurality of computers in any appropriate format. Further, images 150 may be local or remote, as well as temporary or persistent, without departing from the scope of this disclosure. Regardless, image 150 is typically generated at run-time using graphics card 118 for quick presentation through GUI 116.

Computer 102 also includes or presents GUI 116. GUI 116 comprises a graphical user interface operable to allow the user of computer 102 to interface with various computing components, such as development environment 130, for any suitable purpose. Generally, GUI 116 provides the user of computer 102 with an efficient and user-friendly presentation of data provided by or communicated within the computer or a networked environment. In one embodiment, GUI 116 presents images 150 and a front-end for development environment 130 or design engine 132 to the developer. But GUI 116 may comprise any of a plurality of customizable frames or views having interactive fields, pull-down lists, toolboxes, property grids, and buttons operated by the user. Moreover, it should be understood that the term graphical user interface may be used in the singular or in the plural to describe one or more graphical user interfaces and each of the displays of a particular graphical user interface. Therefore, GUI 116 contemplates any graphical user interface, such as a generic web browser or touch screen, that processes information and efficiently presents the results to the user. Computer 102 can communicate data to the developer, a web server, or an enterprise server via the web browser (e.g., Microsoft Internet Explorer or Netscape Navigator) and receive the appropriate HTML or XML responses using network 108 via example interface 112.

Computer 102 may also include interface 112 for communicating with other computer systems, such as a server, over network 108 in a client-server or other distributed environment. In certain embodiments, computer 102 receives third party web controls for storage in memory 120 and/or processing by processor 125. In another embodiment, computer 102 may publish generated images 150 to a web or other enterprise server via interface 112. Generally, interface 112 comprises logic encoded in software and/or hardware in a suitable combination and operable to communicate with network 108. More specifically, interface 112 may comprise software supporting one or more communications protocols associated with communications network 108 or hardware operable to communicate physical signals.

Network 108 facilitates wireless or wireline communication between computer 102 and any other local or remote computer, such as a web server. Indeed, while illustrated as one network, network 108 may be two or more networks without departing from the scope of this disclosure, so long as at least portion of network 108 may facilitate communications between components of a networked environment. In other words, network 108 encompasses any internal or external network, networks, sub-network, or combination thereof operable to facilitate communications between various computing components in system 100. Network 108 may communicate, for example, Internet Protocol (IP) packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

In one aspect of operation of one embodiment, a developer identifies, selects, or generates three or more repeatable textures 140. For example, the developer may identify two source repeatable textures 140a and 140b and generate a decisional texture 140c. In certain embodiments, these two source repeatable textures may be identical to one another prior to modifying the texture coordinates assigned to each vertex used by one (or more) of the source textures 140. Decisional texture 140c is used to dynamically combine the two source textures 140a and 140b to produce new texel fragments. Once the source textures 140 are identified, then the texture coordinates used by at least one of these textures 140 are modified in a particular fashion. The modifications may including rotating, scaling, translating, or any other suitable modification of a characteristic of the particular texture coordinates. In certain embodiments, rotating one of the textures 140 may make the repeated patterns of the identified textures 140 to angle in a different direction, thereby possible reducing the visible pattern in the resulting texel fragments as seen in image 150. Changing the scale between first texture 140a and 140b may reduce the pattern that may form if the pattern of texture 140a has same frequency as the pattern of texture 140b. Accordingly, this modification may increase in importance if first texture 140a and second texture 140b are the same texture. Translation may also be useful when textures 140a and 140b are the same texture. Returning to the example textures in FIGS. 2A-C, example first texture 140a is offset −0.25 texture units in s and t and rotated −3 degrees in image 150a. Example second texture 140b is rotated +3 degrees in image 150b and example third texture 140c is scaled 10x in image 150c. It will be understood that, in certain embodiments, changing one characteristic of any of the identified textures 140 will produce different resulting texel elements or fragments.

Once the coordinates of at least one of the identified repeatable textures 140a has been suitably modified, the source textures 140 are combined or otherwise layered based on the decisional texture 140c. Example third texture 140c is used to determine which percent of each resulting texel element comes from first source texture 140a and which percent comes from second source texture 140b. As illustrated in FIG. 4, this determination may be explained in mathematical terms as:
texel fragment=(140a*140c)+(140b*(1−140c))
In certain embodiments, this equation is computed for each pixel in GUI 116 that uses the resulting texel fragments. Applying this equation to the example textures 140a-c with the example modifications outlined above generates new image 150d, illustrated in FIG. 3D, which includes reduced visible patterns because of the new texel fragments. In certain embodiment, the resulting texel fragments may then be used as a replacement or additional source texel fragments to compute a second new texel fragment, which may have further reduced visible patterns from the first computed texel fragment.

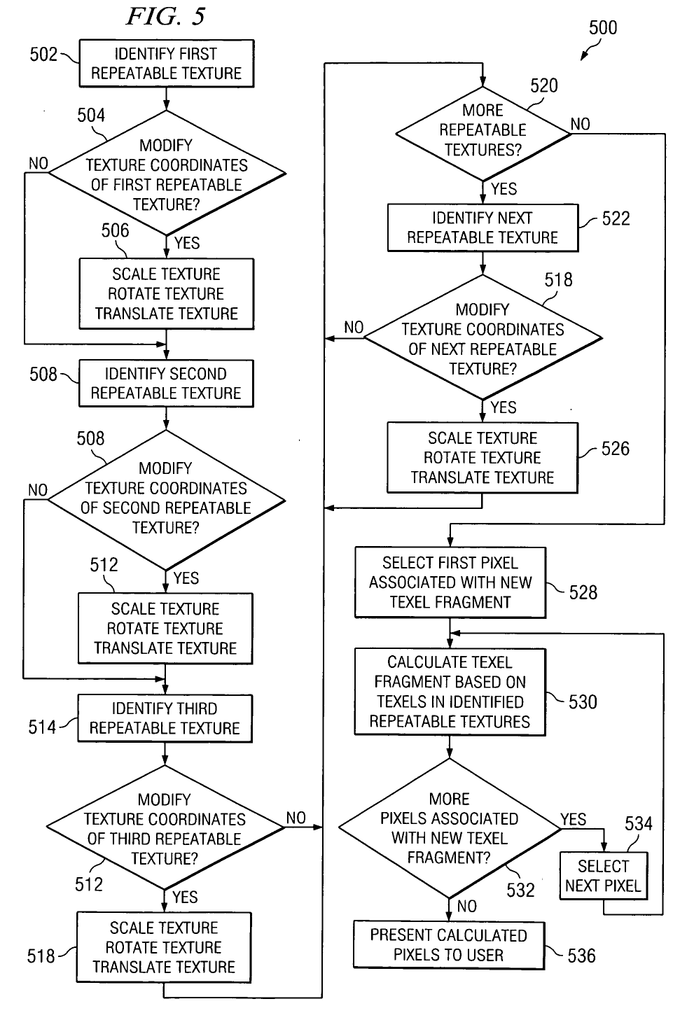

FIG. 5 is a flowchart illustrating an example method 500 for dynamically generating images 150 using repeatable textures 140 in accordance with one embodiment of the present disclosure. At a high level, method 500 includes identifying a plurality of repeatable textures 140, modifying the texture coordinates of at least one of the plurality of repeatable textures 140, and dynamically computing or generating new texel fragments, at least in part, on the plurality of repeatable textures 140. The following description focuses on the operation of certain components of development environment 130 in performing or executing algorithms to implement method 500. But system 100 contemplates using any appropriate combination and arrangement of logical elements, such as a shader executed by graphics card 118, implementing some or all of the described functionality.

Method 500 begins at step 502, where a first repeatable texture 140a is identified. As described above, this identification may occur in response to user selection, based on runtime parameters, or through any other identification process. Next, development environment 130 determines if it is to modify the texture coordinates of first repeatable texture 140a at decisional step 504. If it is, then development environment 130 modifies the texture coordinates used by the first repeatable texture 140a at step 506. For example, development environment 130 may scale first repeatable texture 140a, rotate first repeatable texture 140a, translate one or more parameters used by the first repeatable texture 140a, or perform any other suitable texture coordinate modification. As illustrated, development environment 130 also identifies a second repeatable texture 140b at step 508. Next, at decisional step 510, development environment 130 determines if it is to modify the texture coordinates used by the second repeatable texture 140b. If so, development environment 130 then modifies repeatable texture 140b using any appropriate modification at step 512. As further illustrated, development environment 130 may identify a third repeatable texture 140c at step 514. As with the other textures, development environment 130 determines if it is to modify the texture coordinates used by the third repeatable texture 140c at decisional step 516. If third repeatable texture 140c is to be visually modified, then development environment 130 scales the repeatable texture 140c, rotates the repeatable texture 140c, translates third repeatable texture 140c, or performs any other suitable modification. Next, at decisional step 520, development environment 130 determines there are more repeatable textures to be used to generate the new image 150. If there are, then development environment 130 identifies the next repeatable texture at step 522 and determines if the texture coordinates used by that next repeatable textures are to be modified in decisional step 524. If so, then development environment 130 applies one of the various coordinate modifications to the texture coordinates used by the repeatable texture 140 at step 526 and processing returns to decisional step 520.

Once there are no more repeatable textures to be used as inputs or sources for the new image 150 at decisional step 520, development environment 130, or a shader that is generally executed on the graphics card 118, retrieves a first texel or texels associated with the source repeatable textures 140 in image 150 at step 528 for a given pixel in the frame buffer. Next, development environment 130 calculates a new texel (or texel fragment) for the selected pixel based on the texels retrieved for the various identified repeatable textures 140 at step 530. For example, development environment 130 may apply the algorithm illustrated in FIG. 4 to compute the selected texel fragment for the particular pixel in the image 150. As described above, texel fragment computation may also be performed by graphics card 118—indeed any reference to development environment 130 includes any process operable to executed by card 118, such as a shader, as appropriate. At decisional step 532, development environment 130 determines if there are more pixels in image 150 that need to be calculated using this technique. If there are, then the next pixel in the frame buffer is selected at step 534 and processing returns to step 530. Once all the pixels in the image 150 that are based on the resulting texel fragments have been appropriately computed, calculated, or otherwise determined, then the new image 150 may be presented to the user or developer through GUI 116 at step 536.

The preceding flowchart and accompanying description illustrate exemplary method 500. In short, computer 102 contemplates using any suitable technique for performing this and other tasks. Accordingly, many of the steps in this flowchart may take place simultaneously and/or in different orders than as shown. Moreover, computer 102 may use methods with additional steps, fewer steps, and/or different steps, so long as the methods remain appropriate.

Although this disclosure has been described in terms of certain embodiments and generally associated methods, alterations, and permutations of these embodiments and methods will be apparent to those skilled in the art. For example, development engine 130 may allow the design, development, and generation of images 150 for use in movies, computer games, visual simulation or other CGI. Accordingly, the above description of example embodiments does not define or constrain this disclosure. Other changes, substitutions, and alterations are also possible without departing from the spirit and scope of this disclosure.

1. A method for dynamically generating images using repeatable textures comprises:
identifying a plurality of repeatable textures;
modifying the texture coordinates used by at least one of the identified plurality of repeatable textures; and
dynamically computing a new texel fragment for an image based, at least in part, on the plurality of repeatable textures.

2. The method of claim 1, the plurality of repeated textures comprising a first repeatable texture, a second repeatable texture, and a third repeatable texture.

3. The method of claim 2, the first repeatable texture and the second repeatable texture comprising substantially identical textures.

4. The method of claim 2, each of the plurality of repeatable textures comprising a plurality of texture elements and the new texel fragment comprising a plurality of new texture elements and wherein dynamically computing the new texel fragment comprises dynamically computing each new texture element based on one of the first texture elements from the first repeatable texture, one of the second texture elements from the second repeatable texture, and one of the third texture elements from the third repeatable texture.

5. The method of claim 4, wherein dynamically computing each new texture element comprises:
multiplying the one of the first texture elements times the one of the third texture elements to compute a first product;
multiplying the one of the second texture elements times one minus the one of the third texture elements to compute a second product; and
adding the first product and the second product to compute one of the new texture elements.

6. The method of claim 2, wherein modifying the texture coordinates used by at least one of the plurality of repeatable textures comprises one of the following:
scaling the first texture;
rotating the first texture; or
applying at least one different translation parameter to the first texture.

7. The method of claim 2, each of the plurality of repeatable textures comprising a plurality of texture elements and the texel fragment comprising a plurality of new texture elements and wherein dynamically computing the new texel fragment comprises:
in response to a particular one of the third texture elements being a value of one, assigning a particular one of the new texture elements to a particular one of the first texture's elements; and
in response to a particular one of the third texture elements being a value of zero, assigning a particular one of the new texture elements to a particular one of the second texture's elements.

8. The method of claim 1, the new texel fragment comprising a first new texel fragment and the method further comprising dynamically computing a second new texel fragment for the image based, at least in part, on the subset of repeatable textures and the first new texel fragment, the second new texel fragment associated with a same pixel in the image as the first texel fragment.

9. A system for dynamically generating images using repeatable textures comprises:
memory operable to store a plurality of repeatable textures; and
one or more processors operable to:
identify at least a subset of the plurality of repeatable textures;
modify the texture coordinates used by at least one of the identified subset of repeatable textures; and
dynamically compute a new texel fragment for an image based, at least in part, on the subset of repeatable textures.

10. The system of claim 9, the subset of repeated textures comprising a first repeatable texture, a second repeatable texture, and a third repeatable texture.

11. The system of claim 10, the first repeatable texture and the second repeatable texture comprising substantially identical textures.

12. The system of claim 10, each of the subset of repeatable textures comprising a plurality of texture elements and the new texel fragment comprising a plurality of new texture elements and wherein one or more processors operable to dynamically compute the new texel fragment comprises one or more processors operable to dynamically compute each new texture element based on one of the first texture elements from the first repeatable texture, one of the second texture elements from the second repeatable texture, and one of the third texture elements from the third repeatable texture.

13. The system of claim 12, wherein the one or more processors operable to dynamically compute each new texture element comprises one or more processors operable to:
multiply the one of the first texture elements times the one of the third texture elements to compute a first product;
multiply the one of the second texture elements times one minus the one of the third texture elements to compute a second product; and
add the first product and the second product to compute one of the new texture elements.

14. The system of claim 10, wherein the one or more processors operable to modify the texture coordinates of at least one of the subset of repeatable textures comprises one or more processors operable to process one of the following:
scale the texture coordinates used by texture;
rotate the texture coordinates used by texture; or
apply at least one different translation parameter to the texture coordinates used by texture.

15. The system of claim 10, each of the subset of repeatable textures comprising a plurality of texture elements and the new texel fragment comprising a plurality of new texture elements and wherein one or more processors operable to dynamically compute the new texel fragment comprises one or more processors operable to:
in response to a particular one of the third texture elements being a value of one, assign a particular one of the new texture elements to a particular one of the first texture's elements; and
in response to a particular one of the third texture elements being a value of zero, assign a particular one of the new texture elements to a particular one of the second texture's elements.

16. The system of claim 9, the new texel fragment comprising a first new texel fragment and the one or more processors further operable to dynamically compute a second new texel fragment for the image based, at least in part, on the subset of repeatable textures and the first new texel fragment, the second new texel fragment associated with a same pixel in the image as the first texel fragment.

17. Software for dynamically generating images using repeatable textures operable to:
identify a plurality of repeatable textures;
modify the texture coordinates used by at least one of the plurality of repeatable textures; and
dynamically compute a new texel fragment for an image based, at least in part, on the plurality of repeatable textures.

18. The software of claim 17, the plurality of repeatable textures comprising a first repeatable texture, a second repeatable texture, and a third repeatable texture.

19. The software of claim 18, the first repeatable texture and the second repeatable texture comprising substantially identical textures.

20. The software of claim 18, each of the plurality of repeatable textures comprising a plurality of texture elements and the new texel fragment comprising a plurality of new texture elements and wherein the software operable to dynamically compute the new texel fragment comprises software operable to dynamically compute each new texture element based on one of the first texture elements from the first repeatable texture, one of the second texture elements from the second repeatable texture, and one of the third texture elements from the third repeatable texture.

21. The software of claim 20, wherein the software operable to dynamically compute each new texture element comprises software operable to:
multiply the one of the first texture elements times the one of the third texture elements to compute a first product;
multiply the one of the second texture elements times one minus the one of the third texture elements to compute a second product; and
add the first product and the second product to compute one of the new texture elements.

22. The software of claim 18, wherein the software operable to modify the texture coordinates of at least one of the plurality of repeatable textures comprises software operable to perform at least one of the following:
scale the first texture;
rotate the first texture; or
apply at least one different translation parameter to the first texture.

23. The software of claim 22, wherein the software operable to modify the texture coordinates of at least one of the plurality of repeatable textures further comprises software operable to perform at least one of the following:
scale the second texture;
rotate the second texture; or
apply at least one different translation parameter to the second texture.

24. The software of claim 23, wherein the software operable to modify the texture coordinates of at least one of the plurality of repeatable textures further comprises software further operable to perform at least one of the following:
scale the third texture;
rotate the third texture; or
apply at least one different translation parameter to the third texture.

25. The software of claim 18, each of the plurality of repeatable textures comprising a plurality of texture elements and the new texel fragment comprising a plurality of new texture elements and wherein the software operable to dynamically compute the new texel fragment comprises software operable to:
in response to a particular one of the third texture elements being a value of one, assign a particular one of the new texture elements to a particular one of the first texture's elements; and
in response to a particular one of the third texture elements being a value of zero, assign a particular one of the new texture elements to a particular one of the second texture's elements.

26. The software of claim 17, the new texel fragment comprising a first new texel fragment and the software further operable to a second new texel fragment for the image based, at least in part, on the subset of repeatable textures and the first new texel fragment, the second new texel fragment associated with a same pixel in the image as the first texel fragment.

27. The software of claim 17, further operable to apply a minification, magnification, mip-map, or anisotropic filter prior to computing the new texel fragment.
